(19) United States
(12) Patent Application Publication
(10) Pub. No.: US 2023/0200367 A1
(43) Pub. Date: Jun. 29, 2023

(54) INFLATABLE FLYING INSECT TRAP

(71) Applicant: AP&G Co., Inc., Bayonne, NJ (US)

(72) Inventor: Edward William Dolshun, Warwick, NY (US)

(21) Appl. No.: 18/090,304

(22) Filed: Dec. 28, 2022

Related U.S. Application Data
(60) Provisional application No. 63/294,119, filed on Dec. 28, 2021.

(51) Int. Cl. A01M 1/10; A01M 1/08; A01M 1/14

(52) U.S. Cl. CPC A01M 1/106; A01M 1/08; A01M 1/145; A01M 2200/012

(57) ABSTRACT

An inflatable flying insect trap that serves also serves as a light source. The insect trap is formed of an inflatable globe that, once inflated, forms a curved wall upon which a glue trap may be mounted. One or more LEDs positioned within the cavity of the globe emits light that passes through the globe and through the attached glue trap. Insects attracted to the light will become adhered to the external surface of the glue trap.

### RELATED APPLICATIONS

This application claims the benefit of pending U.S. Prov. Appl. 63/294,119 filed Dec. 28, 2021, the contents of which are incorporated by reference herein.

### FIELD OF THE DISCLOSURE

The present disclosure relates to exemplary embodiments of a fly trap, and more particularly, to exemplary embodiments of an illuminated inflatable fly trap.

### BACKGROUND OF THE INVENTION

Flying insect traps are used in many setting across the globe, including during camping, outdoor activities, and around homes. There is a need in the art for an insect trap that is easily portable and collapsible. There is also a need for a trap that could double as light source—thereby providing, both, light and an effective means of controlling flying insects.

### SUMMARY OF THE INVENTION

Embodiments of the invention provide an inflatable globe having transparent or translucent walls. The walls of the globe are configured for receiving a glue pad. A light source is provided in the globe which emits light through globe walls and through the glue pad thereby attracting flying insects. Flying insects fly to the light source and become trapped on the glue pad.

### BRIEF DESCRIPTION OF THE DRAWINGS

Exemplary embodiments of the present disclosure will be described with references to the accompanying figures wherein:

FIG. 1 is a top perspective view of a globe in an inflated condition according to an exemplary embodiment of the invention.

FIG. 2 is a bottom perspective view of a globe in an inflated condition according to an exemplary embodiment of the invention.

FIG. 3 is perspective view of a glue trap in accordance with an embodiment of the invention.

FIG. 4 is a perspective view of an inflated globe and a glue trap positioned for attachment thereto in accordance with an exemplary embodiment of the invention.

FIG. 5 is a perspective view of an inflated globe and a glue trap partially adhered thereto in accordance with an exemplary embodiment of the invention.

FIG. 6 is a perspective view of an inflated globe and a glue trap fully adhered thereto in accordance with an exemplary embodiment of the invention.

### DETAILED DESCRIPTION OF THE INVENTION

The exemplary embodiments of the present disclosure can provide for an illuminated inflatable fly trap. Exemplary embodiments of the various methods and apparatuses will now be described with reference to the figures. The following description of the various embodiments is merely exemplary in nature and is in no way intended to limit the scope of the disclosure, its application, or uses.

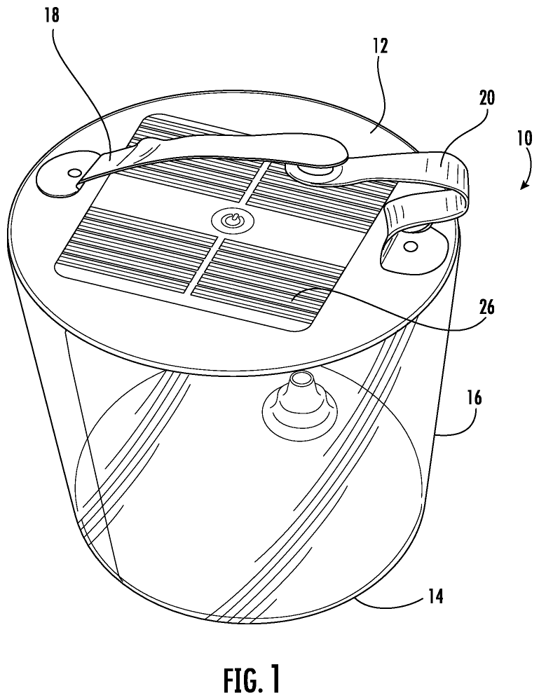

FIG. 1 shows a perspective view of an inflatable globe 10 in an inflated condition, according to an exemplary embodiment of the present disclosure. In embodiments, the globe 10 is cylindrically shaped although other shapes are possible in accordance with other embodiments of the invention. In the embodiment shown in FIG. 1, globe 10 has a top portion 12, a base 14, and curved wall 16 spanning between top portion 12 and base 14. Curved wall 16 has an outer surface that an inner surface. The underside surface of top portion 12, the inside surface of base 14 and the inner surface of curved wall 16 form a hollow inflatable interior chamber. In embodiments of the invention, globe 10 can be made of a plastic material capable of being inflated and deflated. For example, in a deflated position top portion 12 is drawn close to base 14, with curved wall 16 collapsing between top portion 12 and base 14. In the embodiment shown, top portion 12 and base 14 are substantially circular disc-shaped surfaces—but other shapes are possible.

In embodiments of the invention, curved wall 16 is formed of transparent or semi-transparent plastic—which allows for the passage of light.

With continued reference to FIG. 1, an upper surface of top portion 12 is provided with tabs 18 and 20, both with one end attached to the top surface of 12, and the distal end having a fastener such as, but not limited to, a snap. In embodiments the distal ends of tabs 18 and 20 may be secured together with the said fastener to form a “loop.”

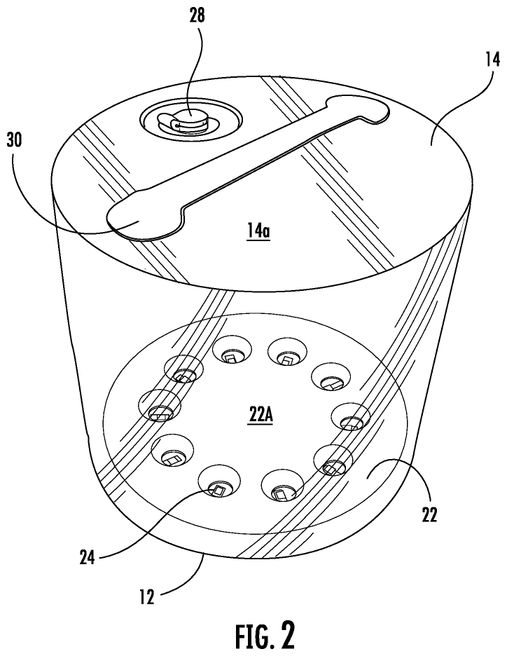

As shown in FIG. 2, in embodiments of the invention, a plate 22 is disposed on an underside surface of top portion 12 of globe 10. In embodiments, an upper surface of plate 22 contacts underside surface of top portion 12 and a bottom surface 22A of plate 22 faces base 14. In embodiments, the lower surface 22A of plate 22 is provided with one or more LEDs 24 or similar light-emitting devices that direct light downwardly into the hollow chamber of globe 10. In embodiments, the transparent or translucent material nature of curved wall 16 and base 14 allow the light emitted from the one or more LEDs 24 to pass through the base 14 and outer curved wall 16. In embodiments, the upper surface of plate 22 can include a solar panel 26, which may provide the necessary power to the one or more LEDs 24 mounted on the lower surface of plate 22. In other embodiments, one or more batteries may be provided for powering LEDs 24.

It will be understood that once inflated, globe 10 comprises an upper, lower, and middle region. In preferred embodiments of the invention, LEDs are provided in the upper region of the globe 10 to project light downward into the hollow of globe and outward.

As best shown in FIG. 2, the base 14 of globe 10 has an underside surface 14A and an inside surface. In embodiments, base 14 is provided with an inflation valve 28 with a plug and stopper to facilitate inflation and containment of the air within the interior of globe 10. In embodiments, the underside surface 14A of base 14 is provided with a tab 30 connected to the underside surface 14A at each end forming a loop by which the globe may be hung or secured.

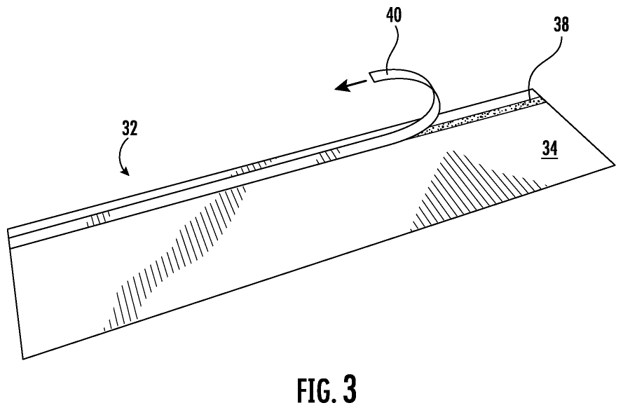

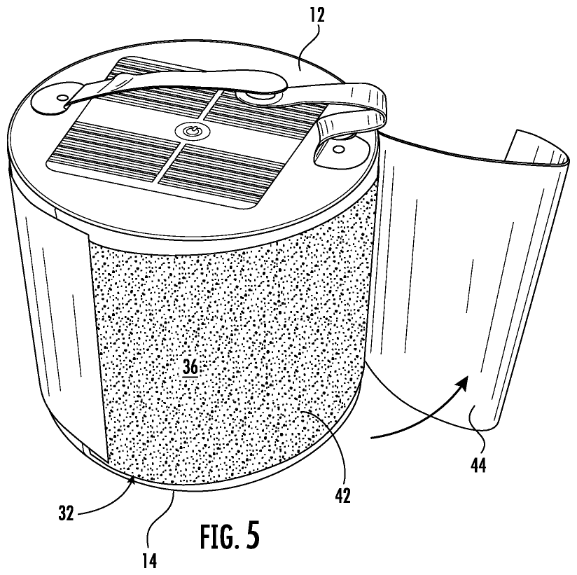

In embodiments, the perimeter formed by outside surface of curved wall 16 of globe 10 is a space configured to be lined with a removeable glue trap 32. With reference to FIG. 3, in embodiments, glue traps 32 configured for use in embodiments of the invention having an inward facing surface 34 and an outward facing surface 36. Inward facing surface 34 is provided with a thin glue strip 38 that is temporarily covered by a removable liner 40. Outward facing surface 36 (best shown in FIG. 5) is substantially fully coated with glue or similar adhesive material 42 that is temporarily covered by a removeable liner 44. Adhesive material 42 is designed to trap adhere flying insect that contact the glue trap 32.

In embodiments of the invention, glue trap 32 and glue/adhesive material disposed thereon is formed of substantially transparent or translucent material to permit the light emitted from the one or more LEDs 24 to pass through. In embodiments of the invention, glue trap 32 is formed of a thin sheet of plastic material upon which the adhesive material such as glue is deposited.

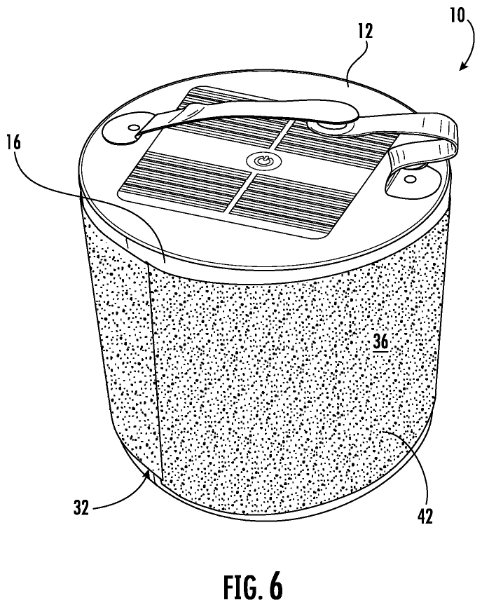

In embodiments of the invention, glue trap 32 has a length that substantially covers the circumference of curved wall 16. The height of glue trap 32 is substantially the same height as curved wall 16 (e.g. the approximate distance between top portion 12 and base 14). It will be understood that in other embodiments of the invention, the height of glue trap 32 is incrementally less than the height of curved wall 16 such that when applied to globe 10, there is a small area of wall surface 16 that is not covered by glue trap 32 (see e.g. FIG. 6).

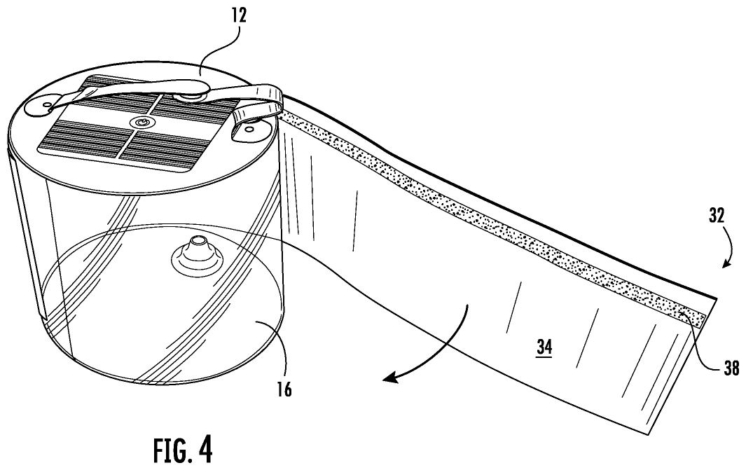

With reference to FIG. 4, in use, a user inflates globe 10 via inflation valve 28 until there is sufficient air within the hollow chamber to maintain curved wall 16 sufficiently firm to receive a glue trap 32. The user then removes liner 40 to expose thin glue strip 38. Next, the user applies inward facing surface 34 of glue trap 32 contacting curved wall 16 of globe 10. Glue trap 32 is secured to curved wall 16 via glue strip 38. As understood, glue trap 32 is applied completely or substantially encircling curved wall 16 created a substantial 360° trapping surface. Once the glue trap 32 is applied to globe 10, removeable liner 44 is then removed exposing glue layer 42. Using tabs 18 and 20 and attached fasteners, globe 10 with mounted fly trap 32 may be hung from or secured to, for example, a pole, tree, or anywhere insects are generally found. Alternatively, globe 10 may be placed upside-down, as shown in FIG. 2, or hung by tab 30.

Once hung as set forth, a user powers on the LEDs 24. As described, because globe 10 and cooperating glue pad 32 are made of transparent or translucent material—the LEDs 24 within globe 10 illuminate through the base 14 and outer curved wall 16 and through glue trap 32. The illumination of the integrated LEDs 24 through the base 14 and outer curved wall 16 of globe 10 have the dual purpose of providing illumination to the surrounding area, while also increasing the effectiveness of the trap, resulting in larger amounts of insets attracted and trapped. When not in use, globe 10 may be deflated and collapsed for easy storage and portability.

Once use is completed, the glue trap 32 may be removed from globe 10. In this regard, because only a thin glue strip 38 is used to interface with globe 10, it is relatively easy to remove the glue trap 32. For future uses, a fresh glue pad 32 may be used.

Various other considerations can also be addressed in the exemplary applications described according to the exemplary embodiments of the present disclosure. For example, various materials may be used to construct the elements described in the figures. Various sizes of the elements can also be provided for various sizes of fly traps. The exemplary embodiments of the present disclosure allows for a compact and portable dual-purpose fly trap and integrated light.

The foregoing merely illustrates the principles of the disclosure. Various modifications and alterations to the described embodiments will be apparent to those skilled in the art in view of the teachings herein. It will this be appreciated that those skilled in the art will be able to devise numerous systems, arrangements, manufacture and methods which, although not explicitly shown or described herein, embody the principles of the disclosure and are thus within the spirit and scope of disclosure.

What is claimed is:

1) A flying insect trap comprising:
a globe comprising an top portion and base;
a curved wall having an outer surface and an inner surface disposed between the top portion and the base;
the top portion, base and curved wall forming an inflatable hollow cavity, whereby when the globe is inflated, an upper region and a lower region is formed;
an inflation valve;
one or more light emitting devices is disposed in the upper region;
a glue trap having first side and a second side, the first side comprising a strip of adhesive material, the second side substantially covered by adhesive material.

2) The flying insect trap of claim 1, wherein the curved wall is formed of transparent or translucent material.

3) The flying insect trap of claim 2, wherein the base is formed of transparent or translucent material.

4) The flying insect trap of claim 2, wherein the glue trap is formed of transparent or translucent material.

5) The flying insect trap of claim 1, whereby the glue trap comprising a width that is substantially equal to a perimeter of curved wall.

6) The flying insect trap of claim 5, wherein the curved wall comprising a height that is substantially equal to the distance between top portion and base when the globe is inflated.

7) The flying insect trap of claim 6, whereby a first side of glue trap is in contact with the outer surface of curved wall.

8) The flying insect trap of claim 1, whereby the one or more light emitting devices comprising one or more LEDs.

9) The flying insect trap of claim 8, whereby light emitted from the one or more LEDs passes through the curved wall and the glue trap.

10) The flying insect trap of claim 8, whereby light emitted from the one or more LEDs passes through the base.
